(19) United States
(12) Patent Application Publication
(10) Pub. No.: US 2004/0073707 A1
(43) Pub. Date: Apr. 15, 2004

(54) Generating a list of network addresses for pre-loading a network address cache via multicast

(75) Inventor: Douglas Dillon, Gaithersburg, MD (US)

Correspondence Address: Hughes Electronics Corporation, Patent Docket Administration, RE/R11/A109, P.O. Box 956, EI Segundo, CA, 90245-0956, US

(73) Assignee: HUGHES ELECTRONICS CORPORATION

(21) Appl. No.: 10/671,808

(22) Filed: Sep. 26, 2003

Related U.S. Application Data
(63) Continuation-in-part of application No. 09/863,157, filed on May 23, 2001.

(51) Int. Cl. G06F 15/16

(52) U.S. Cl. 709/245

(57) ABSTRACT

An approach is provided for multicasting of a list of network addresses that are pre-loaded into caches of the terminals. The list can be generated based on popularity of the domain names, by tracking, for example, hit counts. A predetermined number of the domain names are selected for multicast to the terminals over, for example, a fixed, low bit rate. Upon receipt of the multicast of the list, the domain names are loaded into the terminal's cache in advance of any request by a host to access a device associated with the pre-loaded domain names. This approach as particular applicability in relatively high latency networks, such as a satellite communications system.

### RELATED APPLICATIONS

The present application is a Continuation-In-Part of U.S. patent application Ser. No. 09/863,157, entitled “Caching Address Information in a Communications System” filed on Feb. 25, 2002, the contents of which are hereby incorporated by reference.

### FIELD OF THE INVENTION

The present invention relates generally to a communications system, and is more particularly related to caching address information.

### BACKGROUND OF THE INVENTION

The maturity of electronic commerce and acceptance of the Internet as a daily tool by a continually growing user base of millions of users intensify the need for communication engineers to develop techniques for enhancing network performance. With the advances in processing power of desktop computers, the average user has grown accustomed to sophisticated multimedia applications, which place tremendous strain on network resources (e.g., switch capacity). Also, because the decrease in application response times is a direct result of the increased processor performance, the user has grown less tolerant of network delays, demanding comparable improvements from the network infrastructure. Therefore, network performance enhancing mechanisms are needed to optimize efficiency and reduce user response times. These mechanisms are imperative in systems with relatively high network latency, such as a satellite network.

The robustness of the global Internet stems in part from the naming system that is in place for one machine to communicate with another machine. The naming system that has been adopted is known as the Domain Name System or Domain Name Service (DNS), which permits machines to be identified by “domain names” (i.e., host names), which provide a more readily usable address naming scheme for human recognition; for example, “hns.com”. Applications, such as e-mail or web-browsing, utilize domain names in their communication with remote machines and other processes. This communication requires the translation or mapping of domain names to numeric addresses, such as Internet Protocol (IP) addresses, to reach specific machines. In essence, DNS provides a mapping of domain names to IP addresses. The DNS is a distributed database that stores the domain name, IP address, as well as other information about hosts. The distributed database is implemented by storing various portions of the database across multiple servers in a hierarchical structure—these servers are termed “DNS servers.” Thus, the host associated with the application submits queries to a DNS server for a specific IP address of a particular destination machine.

The queries to and responses (i.e., answers) from the DNS server may require a number of message exchanges to the requesting host as well as other DNS servers. These message exchanges introduce delay in application response times. This delay is particularly prominent when the transmission traverses a network with relatively high latency, such as a satellite network.

Based on the foregoing, there is a clear need for improved approaches for providing address resolution over a relatively high latency network. There is also a need to reduce delay associated with the address resolution process. There is a further need to enhance application response time from the user perspective.

### SUMMARY OF THE INVENTION

The present invention addresses the above stated needs by multicasting of a list of network addresses that are pre-loaded into caches of the terminals (e.g., satellite terminals). Data associated with access of various network devices (e.g., as domain names) within a network (e.g., the Internet) is collected, for example, from a domain name source (e.g., proxy-cache server, DNS server, etc.). The list is generated, according to one embodiment of the present invention, based on popularity of the domain names. For example, hit count information can be used to determine popularity. A predetermined number of the domain names are selected for multicast to the terminals over, for example, a fixed, low bit rate. Upon receipt of the list, the domain names are loaded into the terminal's cache in advance of any request by a host to access a device (e.g., web server) associated with the pre-loaded domain names. Also, the above mechanism for generating the list can be configured to operate redundantly, whereby state information is exchanged between the peers to enhance system availability.

According to one aspect of an embodiment of the present invention, a method of supporting address caching is disclosed. The method includes collecting data indicating access of network devices within a network. The method also includes generating a list specifying addresses corresponding to the network devices based on the collected data. The method also includes preparing a message containing the list, wherein the message is multicast to a plurality of terminals in the network for pre-loading of respective caches of the terminals with the list of the addresses. Under this approach, the user response time is significantly reduced, while system bandwidth is conserved.

According to another aspect of the invention, a system for supporting address caching is disclosed. The system includes a primary component configured to prepare a message containing network addresses of network devices that are accessed, wherein the message is multicast to a plurality of terminals for pre-loading of respective caches of the terminals. Further, the system includes a secondary component configured to redundantly operate with the primary component by communicating with the primary component to receive state information of the primary component. This arrangement advantageously provides an improvement in application response time.

According to another aspect of the invention, a method for resolving network addresses is disclosed. The method includes receiving a request to resolve a domain name to a network address. The method also includes determining whether the domain name corresponds to an entry of a first cache containing a plurality of network addresses that have been multicast from a predetermined terminal, wherein the plurality of network addresses is loaded into the first cache in advance of the receiving step. Also, the method includes in response to a miss in the first cache, determining whether the domain name corresponds to an entry of a second cache that is maintained locally, and if the domain name yields a hit in either of the caches, responding to the request with the network address corresponding to the requested domain name stored in the respective cache. The above arrangement advantageously provides enhanced network performance.

In another aspect of the invention, a network device for resolving network addresses from domain names is disclosed. The device includes a memory configured to cache a plurality of network addresses that have been multicast from a predetermined terminal. The device also includes a communications interface coupled to the memory and configured to receive a request to resolve a domain name to a network address. Further, the device includes a processor configured to determine whether the domain name corresponds to an entry of the memory, wherein the processor selectively responds to the request with the network address corresponding to the requested domain name stored in the memory. Under this approach, the impact of network latency is minimized.

In yet another aspect of the invention, a computer-readable medium storing a data structure for supporting address resolution is disclosed. The medium includes a first section configured to pre-load a plurality of entries, each of the entries includes a domain name and an associated network address, wherein the entries have been multicast for the pre-loading. Additionally, the medium includes a second section configured to store a plurality of entries of domain names and corresponding network addresses that are retrieved independently from the multicast entries. This approach advantageously reduces application response time.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communication system utilizing a proxy architecture capable of supporting Domain Name Service (DNS) multicast pre-loaded caching, in accordance with an embodiment of the present invention;

FIGS. 2A and 2B are diagrams of an architecture for providing transparent proxying in a host computer and a satellite terminal, respectively, in accordance with an embodiment of the present invention;

FIGS. 3A-3D are diagrams of DNS message formats that are utilized in the system of FIG. 1;

FIG. 4 is a diagram of a data structure associated with a DNS cache, according to an embodiment of the present invention;

FIG. 5 is a diagram of incoming and outgoing interfaces for DNS caching, in accordance with an embodiment of the present invention;

FIG. 6 is a diagram of networks components of a Network Operation Center (NOC) for supporting DNS caching, in accordance with an embodiment of the present invention;

FIG. 7 is a diagram of a multicast packet structure for supporting DNS caching, in accordance with an embodiment of the present invention;

FIG. 8 is a diagram of an exemplary data structure for storing domain name hit count information, according to one embodiment of the present invention;

FIG. 9 is a sequence diagram of a DNS request in a transparent proxying architecture, in accordance with an embodiment of the present invention;

FIG. 10 is a sequence diagram of a connection establishment request via a HyperText Transfer Protocol (HTTP) in a transparent proxying architecture, in accordance with an embodiment of the present invention; and

FIG. 11 is a diagram of a computer system that can perform transparent proxying in support of multicasting to pre-load a cache, according to an embodiment of the present invention.

### DESCRIPTION OF THE PREFERRED EMBODIMENT

A system, method, and software for supporting multicasting of a list of network addresses that are pre-loaded into caches of terminals are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is described with respect to the Domain Name System (DNS) and the global Internet, it is recognized by one of ordinary skill in the art that the present invention has applicability to address resolution in a packet switching system, in general.

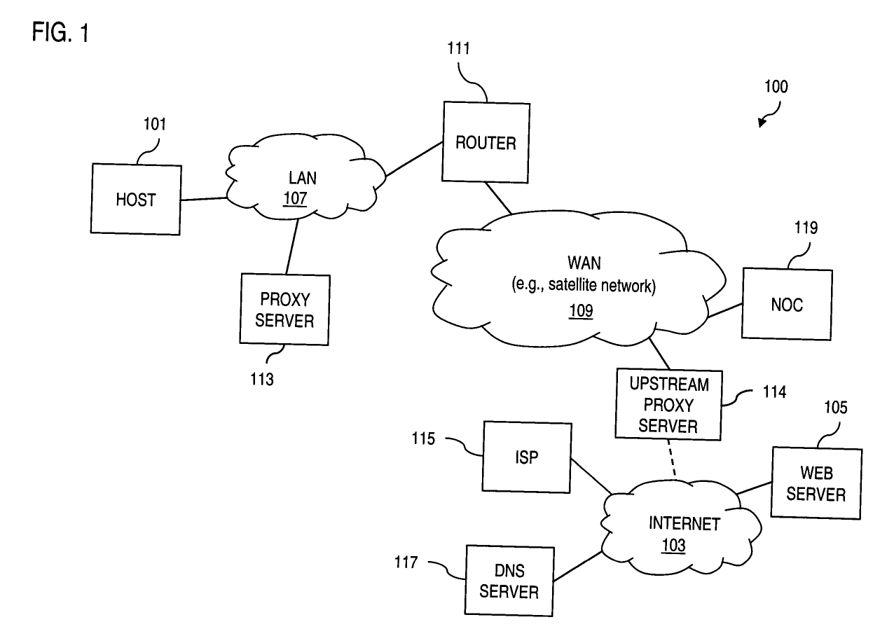

FIG. 1 is a diagram of a communication system utilizing a proxy architecture capable of supporting Domain Name Service (DNS) multicast pre-loaded caching, in accordance with an embodiment of the present invention. A communication system 100 supports enhanced system performance for access by a host 101 to the Internet 103. The host 101 may be any computing device, such as a personal computer (PC), a workstation, web enabled set-top boxes, wireless PDA, webified cell phone, web appliances, and etc. The phenomenal growth of the Web is attributable to the ease and standardized manner of “creating” a web page, which can possess textual, audio, and video content. Web pages are formatted according to the Hypertext Markup Language (HTML) standard which provides for the display of high-quality text (including control over the location, size, color and font for the text), the display of graphics within the page and the “linking” from one page to another, possibly stored on a different web server. Each HTML document, graphic image, video clip or other individual piece of content is identified, that is, addressed, by an Internet address, referred to as a Uniform Resource Locator (URL). As used herein, a “URL” may refer to an address of an individual piece of web content (HTML document, image, sound-clip, video-clip, etc.) or the individual piece of content addressed by the URL. When a distinction is required, the term “URL address” refers to the URL itself while the terms “web content”, “URL content” or “URL object” refers to the content addressed by the URL.

The host 101 is loaded with a web browser (e.g., MICROSOFT Internet Explorer, NETSCAPE Navigator) to access the web pages that are resident on a web server 105; collectively the web pages and the web server 105 denote a “web site.” The host 101, in this example, is attached to a local area network (LAN) 107 and communicates over a wide area network (WAN) 109 through a router 111 (or equivalent network device). A proxy server 113 may be provided to increase system performance by supporting such functions as HyperText Transfer Protocol (HTTP) proxying and Domain Name Service (DNS) proxying. When this proxy server 113 is an optimizing proxy server, it communicates with an upstream proxy server 114, which may be connected to the portion of the WAN 109 near its connection to an Internet Service Provider (ISP) 115; alternatively, the upstream proxy server 114 may be attached to the Internet 103. Essentially, the ISP 115 connects the WAN 109 to the Internet 103.

HTTP is an application level protocol that is employed for information transfer over the Web. RFC (Request for Comment) 2616 specifies this protocol and is incorporated herein in its entirety. As will be described in more detail later, these proxy services (or functions) may also be resident entirely within the host 101 or within the router 111, or a combination thereof. The WAN 109, which may be a satellite network or other wireless network, has connectivity to the ISP 115.

The user enters or specifies a URL to the web browser of the host 101, which in turn requests a URL from the web server 105. The host 101 may need to resolve an Internet Protocol (IP) address corresponding to a domain name of the URL from a domain name service (DNS) server 117. Such a domain name lookup conventionally requires a traversal of the WAN 109 which introduces additional delay. The web server 105 returns an HTML page, which contains numerous embedded objects (i.e., web content), to the web browser.

Upon receiving the HTML page, the web browser parses the page to retrieve each embedded object. The retrieval process requires the establishment of separate communication sessions (e.g., TCP (Transmission Control Protocol) connections) to the web server. That is, after an embedded object is received, the TCP connection is torn down and another TCP session is established for the next object. Given the richness of the content of web pages, it is not uncommon for a web page to possess over 30 embedded objects; thereby consuming a substantial amount of network resources, but more significantly, introduces delay to the user. The establishment of the TCP connection takes one WAN 109 round trip traversal and then the requesting of the URL and receiving its response takes another round trip traversal. Delay is of a particular concern in the system 100 if the WAN 109, in an exemplary embodiment, is a satellite network, in that the network latency of the satellite network is conventionally longer than terrestrial networks. To minimize such delay, the system 100 provides a transparent proxy service, which supports an HTTP proxy and/or a DNS proxy.

The web browser of the host 101 may be configured to either access URLs directly from the web server 105 or from the proxy server 113, which acts as a HTTP proxy. As discussed above, a URL specifies an address of an “object” in the Internet 103 by explicitly indicating the method of accessing the resource. A representative format of a URL is as follows: http://www.hns.com/homepage/document.html. This example indicates that the file “document.html” is accessed using HTTP.

The proxy server 113 acts as an intermediary between one or more browsers and many web servers (e.g., server 105). The web browser requests a URL from the proxy server 113 which in turn “gets” the URL from the addressed web server 105. The proxy server 113 itself may be configured to either access URLs directly from the web server 105 or from an upstream proxy server 113a. When the browser is configured to access URLs via a proxy server 113, the browser does not need to do a DNS lookup of the URL's web server because it is requesting the URL from the proxy server and need only be able to contact the proxy server. The HTTP proxy server 113, according to one embodiment of the present invention, stores the most frequently accessed URLs. When the web server 105 delivers a URL to the proxy server 113, the web server 105 may deliver along with the URL an indication of whether the URL should not be cached and an indication of when the URL was last modified.

According to one embodiment of the present invention, the proxy server 113 may support multicast pre-loading of its cache. IP multicasting can be used to transmit information from a Network Operations Center (NOC) 119 to a number of the proxy servers, including the proxy server 113. As recognized below, the functionality of the proxy server 113 may reside in any machine, as in a host computer (not shown), which may have direct access to the WAN 109; if the WAN 109 is a satellite network, such a host is also referred to as a terminal (or remote terminal).

The process of performing transparent proxying, as the label suggests, is transparent to the client software and is more fully described below. Consequently, this transparency advantageously eliminates the need to pre-configure the client software. A subtle, but important point that is not widely known is that because the proxying of HTTP is transparent to the browser, the browser still has to perform a DNS lookup to convert a URL's web server domain name into an IP address. One of the key benefits of the present invention is to reduce or eliminate the response time impact of this DNS lookup.

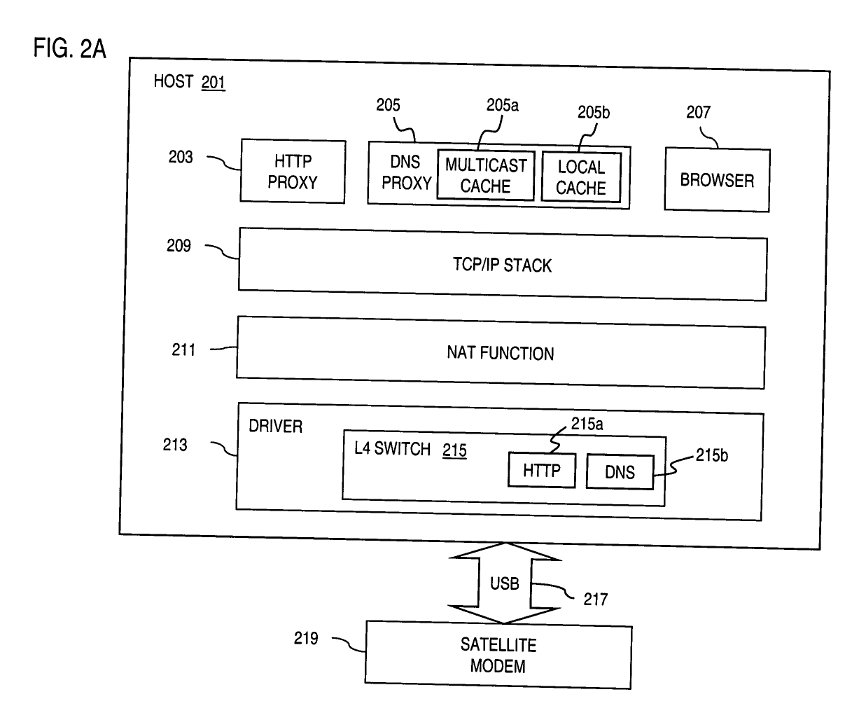

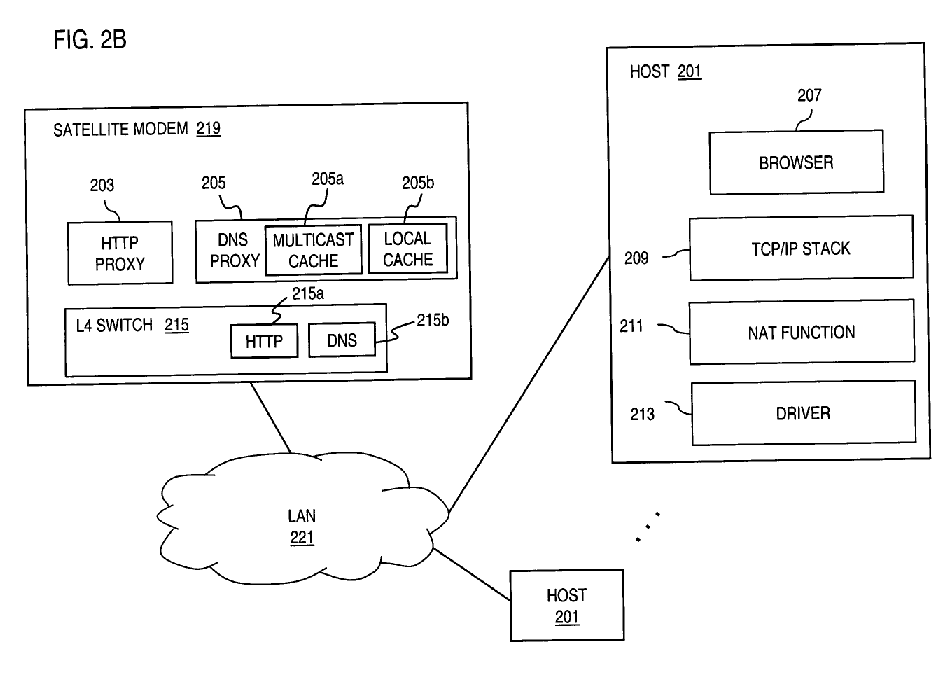

FIG. 2 shows a diagram of an architecture for providing transparent proxying in a host computer, in accordance with an embodiment of the present invention. In this example, the transparent proxy services are implemented in a host 201, such as a personal computer (PC) or a workstation. The host 201 may operate in either a one-way satellite system or a two-way satellite system. In the one-way system, the downstream channel is over the satellite network, while the upstream channel (i.e., return channel) is provided over a terrestrial network (e.g., dial-up modem); however, the two-way system has both upstream and downstream channels over the satellite network. The host 201 couples to a satellite modem 219 via a communications interface 217, which in an exemplary embodiment is a Universal Serial Bus (USB) interface. The transparent proxy services provide transparent routing of HTTP and DNS lookups.

According to one embodiment of the present invention, the host 201 includes two proxy agents: a HTTP Proxy 203 and a DNS proxy 205. The DNS Proxy 205 receives and processes DNS requests. The DNS Proxy 205 handles identically such requests whether they come directly from a client or transparently via the L4 switch 215. The DNS Proxy 205 maintains two DNS caches: multicast cache 205a, and local cache 205b. The multicast cache 205a stores DNS records that are supplied by the NOC 119, while the local cache 205b contains DNS records that are retrieved by the host 201. Although the caches 205a, 205b are illustrated in FIG. 2 as separate caches, it is recognized that the caches 205a, 205b can be implemented as part of a single memory, or separate memories.

Multicast cache 205a contains entries (e.g., list of domain names) multicast from the NOC 119. For example, the entries can be sent in decreasing order of popularity by the NOC 119. That is, the multicast cache 205a, according to one embodiment of the present invention, contains the most popular DNS records as determined by the NOC 119. The DNS Proxy 205 accepts entries beginning with the most popular and simply stops loading subsequent entries should the multicast cache 205a become full. This cache can be configured to a size of 0 bytes for situations where a multicast pre-loaded cache is not required so that the memory is freed up for the local cache 205b.

The Local cache 205b contains a cache of entries received from the DNS Server (e.g., DNS server 117) after a multicast cache miss occurs. In other words, the local cache contains entries of those domains that could not be serviced from the multicast cache 205a, but were retrieved from the Internet 103.

When the DNS Proxy 205 receives a request, the DNS Proxy 205 looks up the domain name in one or both of the caches 205a, 205b. If the DNS proxy 205 is unable to service the request from these caches 205a, 205b, the DNS Proxy 205 sends out a DNS request to the configured DNS server 117 and provides the response to the requestor. The DNS proxy 205 also updates the entry in its local cache 205b. The DNS Proxy 205, when processing a DNS multicast received which does not fit in the Multicast cache, will look up the entry in the Local Cache and, should the lookup succeed, freshen the local cache entry's expiration time.

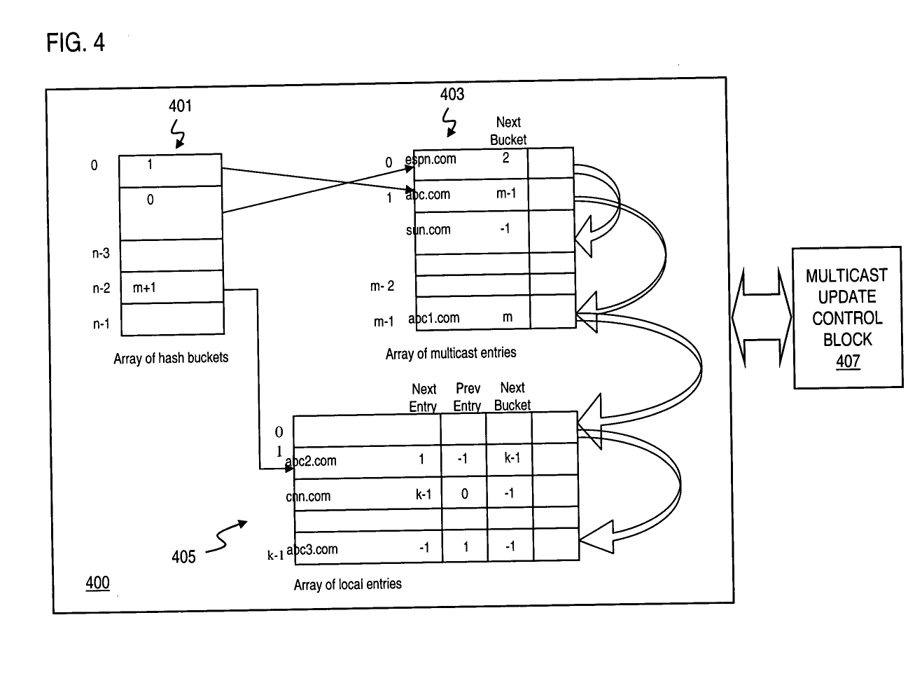

The operation of these caches 205a, 205b are more fully described below with respect to FIG. 4.

A web browser 207 is loaded within the host 201 for retrieving HTTP objects (e.g., text, graphics, etc.) from a web server (not shown). The host 201 utilizes, in an exemplary embodiment, a TCP/IP stack 209 as well as a network address translation (NAT) function layer 211. The NAT layer 211 provides address translation between a private network (i.e., a stub domain), such as a local area network (LAN) 107, and a public network, such as the global Internet 103. Address translation is necessary when the LAN 107 utilizes unregistered IP addresses, for example. The NAT layer 211 is detailed in Internet Engineering Task Force (IETF) Request for Comment (RFC) 1631, entitled “The IP Network Address Translator (NAT),” which is incorporated herein by reference in its entirety. Further, the NAT layer 211, according to an embodiment of the present invention, is utilized as a firewall for blocking undesired traffic.

In this example, a driver 213 (e.g., Ethernet driver) has a Layer 4 switch function 215 to the driver 213. This driver 213 may also be used to provide multicast pre-loaded cache entries to the HTTP proxy 203 and/or DNS proxy 205. As used herein, Layer 4 refers to the transport layer of the OSI (Open Systems Interconnection) model; it is recognized, however, that Layer 4 may denote any equivalent protocol.

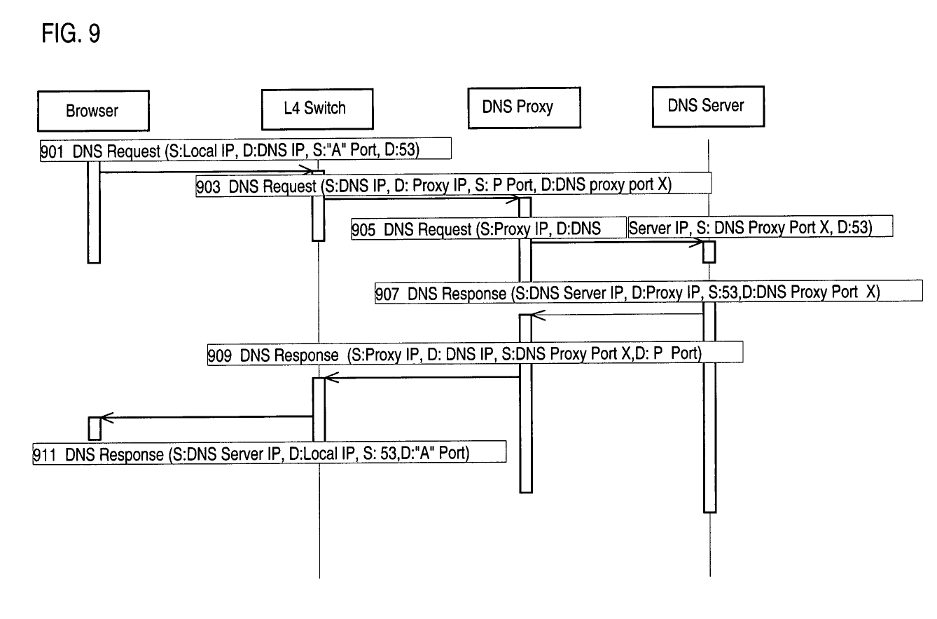

The Layer 4 switch function 215 routes all domain name server lookups (i.e., DNS requests) and HTTP requests traversing the driver 213 up through the stack to their respective proxies 205 and 203. This operation is more fully explained below with respect to FIG. 9. The Layer 4 switch function 215 identifies these requests by examining the port number of the packets, and modifies the addresses and ports to redirect the request packets to the appropriate proxy 205 and 203. It is noted that when the Layer 4 switch function 215 alters the addresses an/or ports, the corresponding TCP or UDP checksum as well as the IP header checksum are appropriately modified. It performs a similar function of modifying packet address and port fields of response packets from the proxies 205 and 203 to route those responses back to the browser 207. To accomplish this, the Layer 4 switch function 215 also maintains the TCP connection control block. This operation by the Layer 4 switch function 215 is more fully described in co-pending application, entitled “Transparent Proxying Enhancement” (Ser. No. 60/271,405), which is incorporated herein by reference in its entirety. It should be observed that while the HTTP proxy 203 relies on TCP, the DNS proxy 205 is based upon the User Datagram Protocol (UDP). Despite the difference in transport protocol used in these two proxies, the Layer 4 switch function 215 is conceptually the same for both HTTP requests and DNS requests. These requests are originated by the browser 207. They may also be originated by an application on another local area network when for example, when MICROSOFT Internet Connection Sharing (or SatServ or some other NAT-based gateway software) is installed on host 201. No reconfiguration of other LAN client's browser or DNS configuration is required to achieve the performance attained by the PC browser 207.

All HTTP accesses are routed through the HTTP proxy 203 to ensure that bandwidth savings mechanisms are employed. On a cache miss, the proxies forward a request through over the WAN 109 to the NOC 119 using either pure TCP, or if HTTP proxy 203 is an optimizing proxy, using a protocol that is optimized for the particular WAN 109.

As mentioned, the transparent proxy services increase the usability of client software by eliminating the need to configure the browser 207 in order to achieve the response time and bandwidth reduction benefits of HTTP proxying. Conventionally, automatic configuration of the browser in existing client software has been required, which, as noted previously, has numerous drawbacks.

By contrast to the traditional approach, the transparent proxy services effectively address the above noted drawbacks by transparently routing HTTP and DNS lookups. Additionally, the transparent proxy services support multicast pre-loading of the DNS cache (not shown), which eliminates the response time impact of most of these DNS lookups. Even non-pre-loaded DNS caching, with long cache entry expiration periods, will sharply reduce impact of DNS lookups. It is noted that transparent proxying and DNS caching may be automatically configured so that they occur only when their associated proxies are operational.

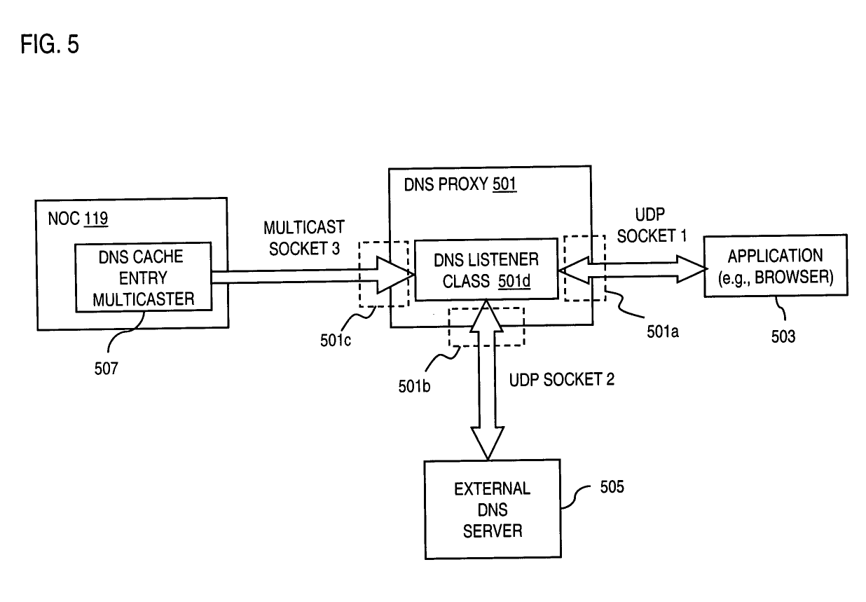

Further, the transparent proxy services include the NOC functions associated with the multicast transmission of DNS cache entries; this includes a number of entities, as further described with respect to FIG. 5. For example, a DNS Cache Entry Multicaster periodically multicasts at a low (e.g., 1200 bps), fixed bit rate DNS cache entries from a list of DNS names. In an exemplary embodiment, this entity may be a MICROSOFT Windows NT service residing on a server within the satellite network's hub earth station (i.e., Network Operations Center 119).

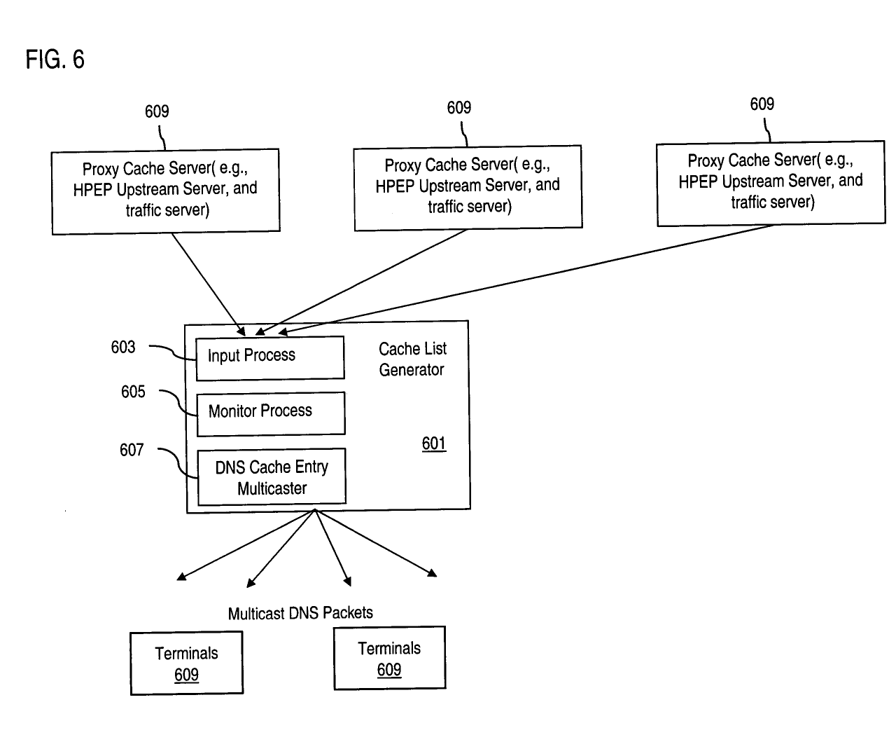

Another entity is a Cache List Generator (CLG), which receives per-URL information from either the proxy servers or a domain name server or other device and creates the list of DNS entries to be multicast by selecting the N most popular names—where N is configurable. The Cache List Generator, which is more fully described with respect to FIG. 6, utilizes three processes to prepare and output the multicast list of domain names to the terminals.

The NOC 119 is responsible for automatically generating the DNS addresses that are to be pre-loaded into caches; these DNS addresses may follow any number of criteria, such as the most popular DNS addresses. The DNS addresses are then multicast by the NOC 119 to the DNS cache. DNS caching passes through DNS lookups when a cache lookup fails, perhaps due to a DNS multicast pre-load outage. The DNS cache is configured to operate as a caching DNS cache even when there is no multicast pre-load. It is noted that the DNS cache interoperates with any other DNS servers either local to the host 201 or on the LAN 107; the DNS cache may, under such circumstances, pass requests from such DNS servers transparently to the NOC 119.

The NOC 119 also supports, according to various embodiments of the present invention, the gathering and multicasting of HTTP data to be pre-loaded into the HTTP proxy 205.

The transparent proxy services provide numerous advantages over the conventional approach. The services of the Transparent Proxy eliminate the need to pre-configure browsers on the PC host to access an HTTP proxy residing on that host. Also, no reconfiguration of the browsers on LAN clients is needed to access an HTTP proxy residing on the host 201.

In an alternative embodiment as shown in FIG. 2B, the Layer 4 switch 215, along with the HTTP proxy 203 and the DNS proxy 205, may reside in the satellite modem 219. In this configuration, the satellite modem 219 can serve multiple hosts 201 via a local area network (LAN) 221.

In addition, although not shown, the Layer 4 switch 215 may be implemented in a network element, such as a router.

The DNS caching terminal software application does not block while servicing any DNS query. The application maintains a Request Control Block (RCB) for each cache-missed DNS request received. The application forwards the DNS request to the external DNS server and starts polling the sockets for any DNS query or multicast or DNS response instead of blocking until the response is available. These RCBs are maintained in an array of a configurable size. Each RCB has a timestamp (e.g., a Time of Arrival field), which is the time at which the request has arrived. If the RCB array is full, an entry that has timed out will ordinarily exist. Each RCB can also contain, for example, following information: a query ID (identifier) for identifying the request, a client address (e.g., IP address), hashing (e.g., MD5 hash) of the domain name, and a count of domain name servers contacted for this query. MD5 is a one-way hash algorithm, and is detailed in IETF RFC 1321, entitled “The MD5 Message-Digest Algorithm,” which is incorporate by reference in its entirety. It is noted that although the present invention is described with respect to MD5, any hash algorithm may be utilized.

Because the application (DNS request originator—typically web browser 503) manages the timeouts and retransmission, under certain circumstances, the application can retransmit the requests while the response from the external DNS server is still in transit. To address such cases, before creating a RCB for any cache-missed request, the RCB array is scanned for already existing entry and if found, its timestamp is set to the current system time. In case of responses being received for requests that have timed out, these responses are nonetheless still sent to the requesting application, whereby the local cache is updated.

In the event that the contacted domain name server does not reply, the next time when the same query is received, it is forwarded to the next domain server in a configured list containing designated servers—provided that its RCB has not been allocated to some other request. If the RCB has been allocated to some other query, then the request will again be sent to the first domain name server in the configured list. After sending the response, RCB is marked free. Responses that do not have corresponding RCBs are discarded. A new received DNS request is discarded if the RCB array is full and all the RCBs are fresh.

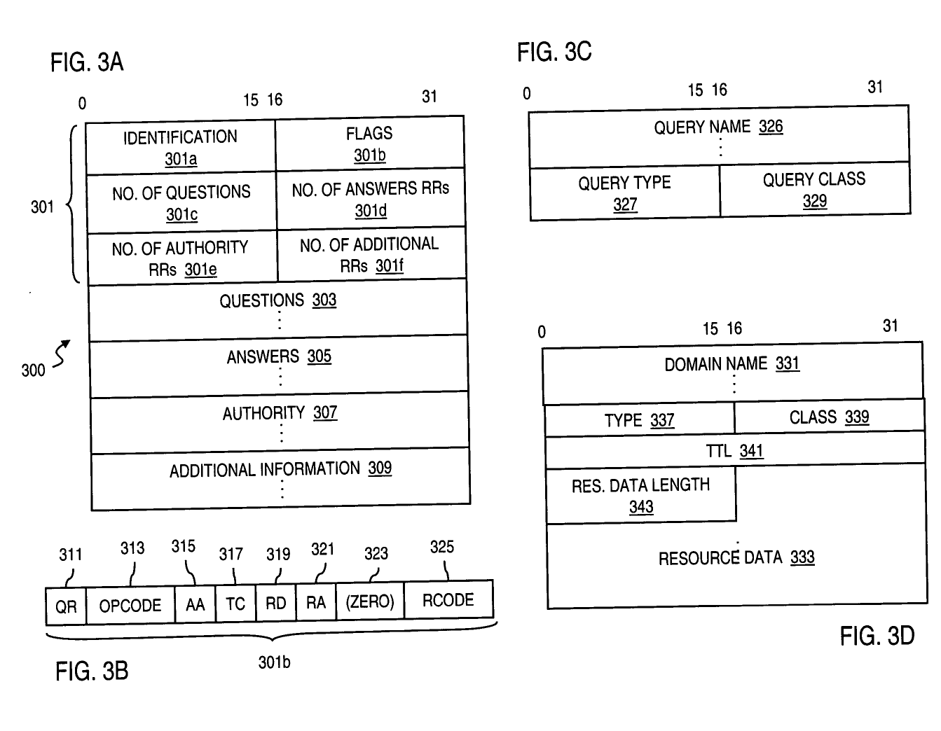

To better appreciate the operation of the DNS proxy, it is instructive to examine the structures of the DNS messages, as described in FIGS. 3A-3D. The DNS proxy operation is also detailed in “TCP/IP Illustrated, Volume 1” by W. Richard Stevens; which is incorporated herein by reference in its entirety.

FIGS. 3A-3D are diagrams of DNS message formats that are utilized in the system of FIG. 1. The format of DNS message defined for both queries and responses is as follows. As seen in FIG. 3A, a DNS message 300 has a fixed 12-byte header 301 followed by four variable-length fields 303, 305, 307, 309. Specifically, the header 301 includes an Identification field 301a, a Flags field 301b, a Number of Questions field 301c, a Number of Answers Resource Records (RRs) field 301d, a Number of Authority RRs field 301e, and a Number of Additional RRs field 301f. The Identification field 301a is set by the client and returned by the server, allowing the client to match responses to requests. In an exemplary embodiment, Resource Records are specifications for a tree structured name space and data associated with the names; conceptually, each node and leaf of the domain name space tree names a set of information, which is maintained, as resource records.

The 16-bit Flags field 301b is divided into numerous sub-fields, as shown in FIG. 3B. A QR field 311 is a 1-bit field: a “0” indicates that the message is a query, and “1” indicates a response. An Opcode (Operational Code) field 313 is a 4-bit field, which in the normal value is 0 (a standard query); other values are 1 (an inverse query) and 2 (server status request). An Authoritative Answers (AA) field 315 is a 1-bit flag to indicate whether the name server is authoritative for the domain in the question section. A Truncated (TC) field 317 specifies whether the reply is truncated, and can be implemented as a 1-bit field; with UDP, the field 317 is set if the total size of the reply exceeds 512 bytes, and that only the first 512 bytes of the reply was returned. A Recursion Desired (RD) field 319 is 1-bit in length and is set in a query and is then returned in the response. This field 319 instructs the name server to handle the query itself—i.e., a “recursive query.” If the RD field 319 is not set, and the requested name server does not have an authoritative answer, the requested name server returns a list of other name servers to contact for the answer—i.e., an “iterative query.” A Recursion Available (RA) field 321 is a 1-bit field that is set to 1 in the response if the server supports recursion.

In an exemplary embodiment, the Flags field 301b utilizes a field 323 for 3 bits of zeros between the RA field 321 and a Return Code (Rcode) field 325. The Rcode field 325 is 4-bits in length: common values include “0” (no error) and “3” (name error). A name error is returned only from an authoritative name server and indicates that the domain name specified in the query does not exist.

Returning to FIG. 3A, the 16-bit fields 301c, 301d, 301e, 301f specify the number of entries in the respective four variable-length fields 303, 305, 307, 309. For a query, the Number of Questions field 301c is typically 1. For a reply, the Number of Answers field 301d is at least 1. The Answer field 305 contains RRs that answer the question. The Authority field 307 contains RRs that point toward an authoritative name server. The Additional Information field 309 contains RRs which relate to the query, but are not strictly answers for the question.

FIG. 3C shows an exemplary DNS query message format. A Query Name field 326 specifies the name of the query that is to used in the look up and can be a sequence of one or more labels. Each of these labels begins with a 1-byte count that specifies the number of bytes that follow. The name is terminated with a byte of 0, which is a label with a length of 0, which is the label of the root. Each count byte can be in the range of 0 to 63, since labels are limited to 63 bytes.

Each question has a Query Type field 327. The most common query type is an A type, which means an IP address is desired for the query name. A PTR (pointer) query requests the names corresponding to an IP address. A Query Class field 329 is typically set to 1, indicating an Internet address; however, it is recognized that other non-IP values can also be supported at some locations.

FIG. 3D shows an exemplary DNS response message format. A Domain Name field 331 provides the name corresponding to the resource data, which is stored in a Resource Data field 333. A Type field 337 and a Class field 339 store information similar to the fields 327, 329 of the DNS query message. The Type field 337 specifies one of the Resource Record (RR) type codes, which are the same as the query type values described above. The class is typically 1 for Internet data. The response also includes a time-to-live (TIL) field 341, which specifies the number of seconds that the client can cache the RR, and, according to an embodiment of the present invention, is set to 2 days. Also, a Resource Data Length field 343 specifies the amount of resource data; the format of this data depends on the type. For example, if the Type field is set to 1 (i.e., an ‘A’ type record), the resource data is a 4-byte IP address.

FIG. 4 is a diagram of data structures associated with a DNS cache, according to an embodiment of the present invention. The DNS Proxy maintains two types of records: records that are multicast from the NOC 119, and records that are generated due to requests on the local client and could not be resolved via the multicast cache. For the purposes of explanation

A single instance of a DNS cache 400 is maintained at any point of time. The cache 400, according to one embodiment of the present invention, is maintained as a combination of a hash table 401 and associative arrays 403, 405 for multicast entries and for local entries. These arrays 403, 405, for the purposes of explanation, are referred to respectively as a multicast cache 403 and a local cache 405.

Collisions are handled by chaining. The hash table 401 contains the index into the associative array of the first element in the chain. The associative array contains the DNS records and the index to the next element in the chain.

According to an embodiment of the present invention, the array 403 of multicast entries and the array 405 of local entries have a common hash bucket 401. As seen in FIG. 4, the size of the array of hash buckets is n, the size of array 403 of multicast entries is m, and the size of array 405 of local entries is k. It is noted that n=(m+k). The array 403 of multicast entries is created from the DNS records multicast from the NOC 119. The array 405 of local entries contains the DNS records for the queries that could not be serviced from the multicast cache, and thus, required response from the configured DNS server.

When a name is to be resolved, the multicast array 403 is searched first and then the local array 405. This is enforced by ensuring that a name that cannot be resolved from the multicast cache 403 and if the name is to be added to the array 405 of local entries then it is added to the end of the chain for that hashed index.

According to one embodiment of the present invention, the DNS record that is cached includes following information: domain name hash (e.g., MD5 hash), TTL, Flags, and IP address. A cache entry, for example, can be restricted to containing the following data: Domain Name Hash, IP address, and Expiration Time And Flags. According to one embodiment of the present invention, the Domain Name Hash is a 64-bit MD5 Hash of the entry's domain name. The IP address is associated with the domain name. The MD5 hash is 8 Bytes in length. The domain names are converted into lower case before applying the MD5 hash. To conserve memory, the 128 bit MD5 would be reduced to 64 bits by, for example, an exclusive-ORing together the first 8 bytes with the last 8 bytes. Each of the caches has an aging policy based upon a TTL to prevent return of stale records in response to standard queries. The TTL which is 3 Bytes, can be stored as an absolute time when the record will expire and is calculated as follows:

TTL=(TTL received+current system time)>>8.

This calculation is performed in the case of local cache insertion; as regards the multicast cache 403, according to one embodiment of the present invention, it is already transmitted as an absolute time. The current system time is converted into Greenwich Mean Time (GMT). The Flags is 1 Byte and is reserved for later developed applications. The IP address is IPv4, and thus, is 4 Bytes; however, IPv6 can also be used.

In addition, the two arrays 403, 405 contain a Next Bucket field, which is a two-byte index of the next entry in the chain. When this index needs to point to an element in the local array 405 then it will be stored as m+index where m is the size of the multicast array 403. For example, a value of −1 is stored to designate a last entry in the chain.

Further, the array 405 of local entries also contains two two-byte indexes, Next Entry and Prev Entry, to implement an LRU algorithm. Whenever a DNS entry is used (i.e., cache-hit) or created, it is moved to the end of the doubly linked list. In this manner, the least recently used is brought to the front of the list. Under this approach, aging out of records from the local cache 405 is readily performed when the cache 405 becomes full.

The local cache 405, in an exemplary embodiment, can be of a fixed size. When the cache 405 becomes full, the entries of the cache 405 are removed from the cache 405, and a new entry is to be added. Accordingly, an existing entry is replaced with the new entry. The approach to determining the DNS record to be replaced is as follows. Initially, the least recently used entry is obtained (i.e., first node of the doubly linked list), and replaced with the newly resolved domain name. Next, for the entry being removed, its links in the chain are updated. Next, the entry is added to the tail of the doubly linked list.

If the DNS response contains more than one IP address resolved for a domain name, only one IP address is picked randomly and stored in the cache. This enforces the fixed size cache record and thus eliminates the need of allocating/deallocating memory; the process allocating/deallocating memory is highly undesirable in a real time environment. The DNS proxy 205 performs a refresh of a cache entry if a hit occurs within a configurable limit close to the end of the life of the cache entry—i.e., whose TTL is about to expire.

According to one embodiment of the present invention, the DNS Proxy is implemented as simply as possible. The DNS proxy supports host-to-address translation—i.e., queries with opcode set to 0. For all other queries e.g. in-addr-arpa type, PTR type etc., it forwards the query to the configured DNS server and returns the response without caching it. Also, the DNS proxy can be made to support only UDP requests. The DNS proxy does not return authoritative answers (AA); that is, the AA bit is not set in its response to the name resolver. For simplicity, the DNS proxy can be implemented to not support Inverse Queries and zone transfer requests.

Because most common applications (e.g., browser, ftp client) send a DNS query with only one question, any query with more than one question is treated as a cache miss and is forwarded to the external DNS server. Also, the DNS proxy does not manage retransmission timeouts and retries. The DNS proxy returns one answer resource record (RR); however, the DNS Proxy can cache more than one IP addresses resolved for a domain name. The DNS proxy selects an address randomly from its cache and returns as the DNS response. In this manner, the DNS proxy does not reduce the load balancing performed by the web servers.

As shown in FIG. 4, a Multicast Update Control Block (UCB) 407 is maintained to avoid repeat updating of DNS records in the multicast cache 403 after receiving the multicast records. The UCB 407 utilizes, according to one embodiment of the present invention, three variables to track versions of the DNS records that are multicast from the NOC 119 and stored in the multicast array 403: an X value that indicates when the list of domain names changes, a Y value that specifies when the generated domain name list is regenerated with reset TTLs as well as when expiration of the youngest entry lapses, and a Z value is used as a sequence number. If Z is 2 bytes, the maximum number of packets that can be multicast are 65535. To avoid large memory consumption, the number of records that the multicast cache can hold determines the size of the array 403. Thus, there is 1 bit for each allowable Z in the multicast cache 403. For example, if the multicast pre-load cache size is 2048, the array 403 size would be 256.

Whenever a packet with different X arrives, all bits in the array 403 are reset to zero. When a Y version update packet is received, the sequence number Z is read. The corresponding index (CI) in the array of entries (packet sequence number * N) is calculated. If CI<m* and the array entry at Z−1 is 0, then update the TTL and the IP address of all elements in the array of multicast entries beginning at entry CI; thereafter, the Z−1 entry is set to 1. Where m* is the size of the multicast cache (the size of array 403 is=m/8+1), and N is the maximum number of records in a packet. If CI>=m* and the Z−1 entry is 0, then for each domain name in the packet search the array 405 of local entries and update the TTL and IP address if the MD5 matches with any of the entries; the Z−1 entry is set to 1.

When an X version update packet is received, the sequence number Z is read, and the corresponding index (CI) is calculated. If CI<m* and the Z−1 entry is 0, then the links for the existing chains whose elements are being overwritten are updated. The DNS records in the array 403 of multicast entries are overwritten, beginning at entry CI. The hash index for the new DNS entry is calculated. A link to this element is added to the beginning of the chain at that hash index. Thus, even if there are duplicates in the multicast cache 403, the last record received for a record is retrieved and the domain name resolved per the latest record is received. A duplicate occurs only if the popularity of a domain changes. When a new packet number is received, that duplicate record is overwritten; then, the Z−1 entry is set to 1. If CI>=m* and the Z−1 entry is 0, then for each domain name in the packet, the array 405 of local entries is searched, and the TTL and IP address if the MD5 matches with any of the entries are updated. Also, the Z−1 entry is set to 1.

According to one embodiment of the present invention, the DNS Proxy application is a single-threaded application. Thus, special care has to be taken to avoid long delays for servicing any DNS request, while the multicast cache is being updated after receipt of the multicast data from the NOC 119. Thus, when the multicast records are to be inserted (i.e., updated) in the multicast cache, the DNS Proxy can service the DNS requests without any significant delay because, in an exemplary embodiment, the NOC 119 does not transmit the multicast cache contents all at once, instead the contents are segmented into packets of size 1200 bytes. The remote terminals process one packet at a time only.

DNS caching terminal software application advantageously does not block while servicing DNS queries. The RCB is maintained for each cache-missed DNS request received. The DNS request is forwarded to the external DNS server, and the application starts polling sockets for any DNS query or multicast or DNS response instead of blocking until the response is available. The application maintains these RCBs in an array with a size that is configurable.

FIG. 5 is a diagram of incoming and outgoing interfaces for DNS caching, in accordance with an embodiment of the present invention. As seen in FIG. 5, a DNS proxy 501 listens on three ports 501a, 501b, 501c, which, in conjunction with the network address associated with the DNS proxy 501, define three corresponding sockets, Socket 1, Socket 2, and Socket 3. The DNS Proxy 501 includes a DNS Listener class 501d that abstracts the handling of incoming/outgoing messages from the NOC 119, an application 503 (e.g., browser), and an External DNS Name Server 505.

In an exemplary embodiment, the sockets are UDP sockets, and hence, are referred to as UDP Socket 1, UDP Socket 2, and UDP Socket 3. The UDP Socket 1, and UDP Socket 2 are used for sending/receiving DNS requests and responses, while the UPD Socket 3 is used for receiving the multicast data. The UPD Socket 1 is established between the application 501 sending the DNS query and the DNS Proxy 501, which listens on the configured port 501a (e.g., default 53) for all DNS queries generated by the application. The DNS proxy 501 and an external DNS Name server 505 communicate via the UDP Socket 2; such that in a cache miss for a particular DNS query, the DNS Proxy 501 calls an appropriate method of a DNS Listener class 501d to send this query to Name Server 505 and to get the response from Name Server 505. The UDP Socket 3 is used by the DNS Proxy 501 to receive multicast records from NOC 119, specifically a DNS Cache Entry Multicaster 507 within the NOC 119.

The DNS Proxy 501 also tracks various statistics, which can be employed to fine-tune the configuration of DNS proxy 501; for example, the number of local cache hits can guide the local cache size. Table 1 lists exemplary statistics.

TABLE 1
STATISTIC

Number of multicast cache hits
Number of local cache hit
Time when last multicast packet was received
Number of invalid multicast packets received
Number of invalid request packets received
Number of invalid response packets received
Number of ‘A’ type DNS request received
Number of other types of query received
Number of Requests Timed out
Time taken in serving the request from the cache
Average Time taken for serving the request which
could not be served from the cache
Number of valid dropped requests because of non-
availability of RCB slot

The DNS Proxy 501, according to one embodiment of the present invention, supports Application Programming Interfaces (APIs) through which the above statistics are use by a Simple Network Management Protocol (SNMP) agent may be accessed. Also, these statistics can be dumped after every Nth request is served, where N is a configurable value.

FIG. 6 is a diagram of networks components of a Network Operation Center (NOC) for supporting DNS caching, in accordance with an embodiment of the present invention. As mentioned previously, the Cache List Generator 601 is responsible for preparing the list of domain names for pre-loading into the caches of hosts (e.g., host 201). The CLG 601 provides the following processes: an Input Process 603, a DNS Cache Entry Multicaster 607, and a Monitor process 605. These processes 603, 605, 607 operate to generate a list of domain names for multicasting.

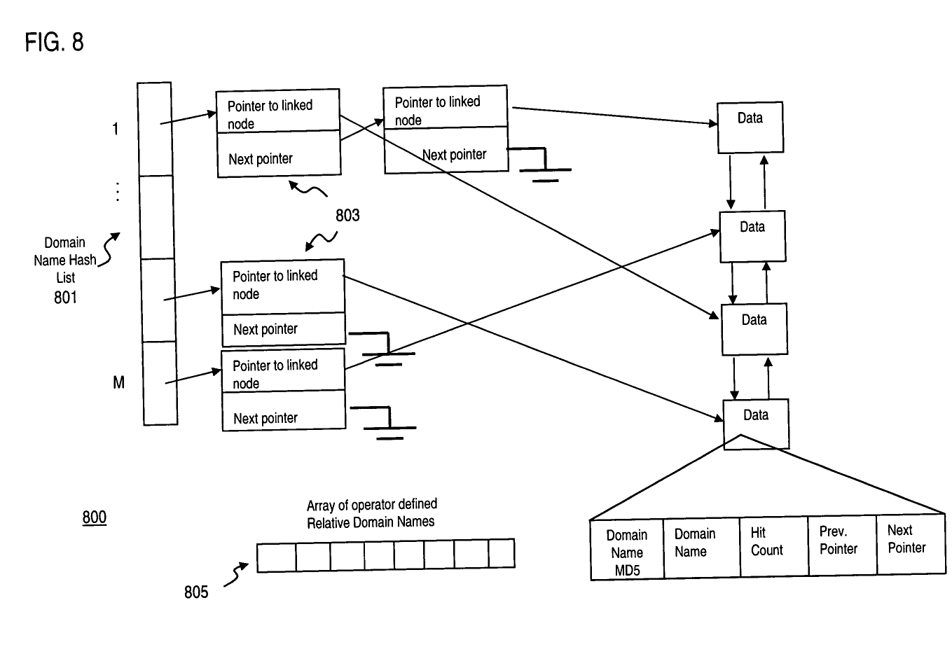

The Input Process 603, in an exemplary embodiment, is a single threaded application that is started and stopped by the Monitor Process 605. The Input Process 603 can run irrespective of its current state. The Input Process 603 monitors events such as state changes with respect to Shutdown and Out-Of-Service states, and sets the following events: Alarm (no data from the DNS server or HTTP Proxy server), Clear Alarm (data from DNS server or HTTP Proxy server). The Input Process 603 has the responsibility of adding the domain name frequency information to a storage structure (shown in FIG. 8) such that DNS record gets added/updated based upon its hit count. Further, the Input Process 603 can reduce the popularity of all the domain names in its storage structure by some configurable percentage. The Input Process 603 periodically checks for the time at which the storage structure needs to be dumped in a file for the DNS Cache Entry Multicaster 607 to work on it. Whenever this occurs, the Input Process 603 re-reads an Initialization (INI) file to be written. The INI file contains start-up information about an application program and user preference information. Additionally, the Input Process 603 produces the domain name information file to be passed to the DNS Cache Entry Multicaster 607. This data file, in an exemplary embodiment, is an ASCII (American Standard Code for Information Interchange) file, having delimiters that assist with ease of importation into, for example, a database or a spreadsheet.

The Monitor Process 605 is a master process of the Input Process 603 and the DNS Cache Entry Multicaster 607. For example, the Monitor Process 605 monitors and controls the state transitions and provides notifications to the Input Process 603 and the DNS Cache Entry Multicaster 607.

The Monitor process 605, in an exemplary embodiment, runs as a MICROSOFT® Windows NT Service and creates the Input Process 603 and the DNS Cache Entry Multicaster 607 on startup. The Input Process 603 collects domain name popularity data from various sources 609; e.g., HTTP Proxy Upstream server, a proxy-cache server (e.g., manufactured by INKTOMI®) and other sources of domain name information. Such servers intercept requests from web clients to retrieve content from a web server, storing the request and associated content locally in the event similar requests are submitted, thereby avoiding delay and conserving system bandwidth. To accept data from these sources, the Cache List Generator 601 implements a protocol using whichever domain name sources that can send their domain name popularity data, thereby ensuring authenticity of source of information. Additionally, the Cache List Generator 601 reads operator defined absolute domain names and relative domain name strings, which are given more priority than the other domain name received from other sources.

The DNS Cache Entry Multicaster 607 is responsible for reading files from the Input Process 603. The DNS Cache Entry Multicaster 607 can apply, for example, a merge sort to gather the top N most popular domain names. The DNS Cache Entry Multicaster 607 resolves the IP addresses and TTL for first N popular domain names. Additionally, the DNS Cache Entry Multicaster 607 creates and maintains versioning of multicast packets; in an exemplary embodiment, the DNS packets are multicast at a low, fixed bit rate (e.g., 1200 bps). Further, the DNS Cache Entry Multicaster 607 buffers all of the generated packets in a pre-allocated buffer, such buffering facilitates retransmission of the packets and update of data on expiration of TTL.

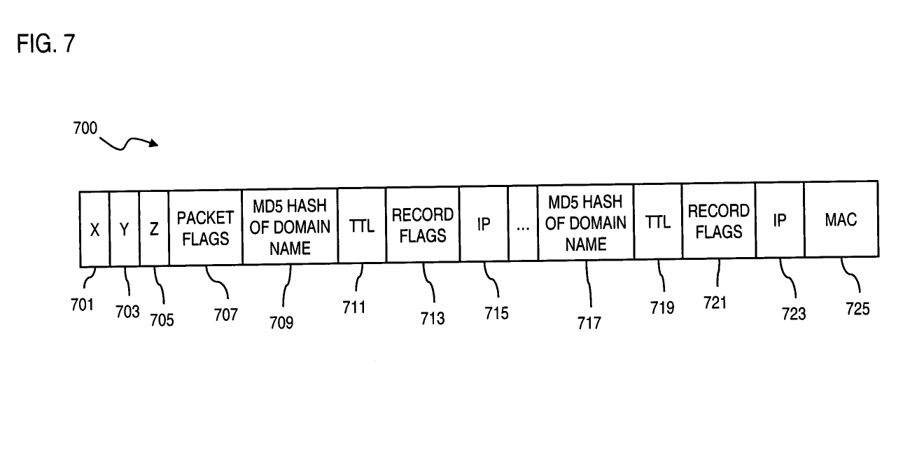

FIG. 7 is a diagram of a multicast packet structure for supporting DNS caching, in accordance with an embodiment of the present invention. A UDP packet 700 is a fixed size packet, for example, of 1200 Bytes, including a 4-byte header 701-x907. The header includes the following fields: ‘X’ version field 701 (1 Byte), a ‘Y’ field 703 (1 Byte), a ‘Z’ field 705 (packet sequence number, 2 Byte), and Packet Flags field 707 (1 Byte). The X value of the X field 701 is incremented when the list of domains for which the response is being multicast changes. The Y value of the Y field 703 is incremented when the same list is regenerated with fresh TTLs, and IP address resolution after the TTL of the youngest entry in that list expires. The Cache List Generator 601 maintains a minimum TTL for each DNS record to multicast, which would account for transmission time from the Cache List Generator to the remote terminals. This would be assigned to TTL of the DNS records whose TTL received from the external DNS server is less than a configurable value.

During the time when the same list is retransmitted, the DNS proxy 205 can compare the version number of its cache with that being transmitted so that it can process the packet in an optimized fashion. The X value contained in the X field 701 is used to avoid the repeat updating of the multicast DNS packets. Z gets incremented for each UDP packet for any X and Y.

For example, if the resolution for 800 DNS entries are being multicast by the NOC 119 and each entry takes 16 Bytes then each UDP packet can accommodate 73 DNS records. In such an example, 14 such UDP packets are generated with their Z component of the version ranging from 1 to 14. The DNS resolution for the most popular domain names contains the Z component of the version as 1, while the least popular amongst the multicast records will have a 14. The 1 Byte Flags field can be reserved for later developed functionality.

It is noted that the DNS response contains fields that can be generated by the DNS Proxy 205. Hence, the NOC 119 does not need to transmit a complete record for a DNS request but only those fields that are essential and cannot be generated locally.

The UDP packet 700 also includes a MD5 Hash of the Domain name (8 Bytes) field 709, which is the name for which the resolution is provided. A TTL field 711 is 3 Bytes and stores the time for which this answer is valid. DNS servers generally keep the TTL as a 4-byte field with a granularity of seconds. The TTL multicast is calculated as follows:

If (TTL received<Min TTL)

TTL multicast=(current system time+Min TTL)>>8

Else

TTL multicast=(TTL received+current system time)>>8

The current system time can be converted into GMT (Greenwich Mean Time).

A Record Flags field 713 can be a reserved field. An IP Address field 715 (4 Bytes in the case of IPv4; it is noted that IPv6 can be employed) is provided for the IP address of the domain name associated with field 709.

In case of multiple IP addresses for one domain name, one record for each IP address would be created in the multicast packet. The maximum number of IP addresses that can be sent for a domain name is configurable and by default, for example, is set to 1. Thus, each DNS record that is to be multicast is of 16 bytes. The maximum number of packets that can be transmitted for a given X and Y are 65535 as Z is 2 byte. The maximum number of DNS records which can be multicast with this packet formation are 4,784,128. In case the configured number of DNS records to multicast exceeds this limit, a fatal error is posted and the system exits.

Fields 717-923 correspond to the next DNS record, such that the packet 700 contains N number of such records. The Cache List Generator 601 appends a Message Authentication Code (MAC) 725 at the end of the packet 700, such that the DNS caching terminal software would only accept multicast packets whose Message Authentication Code matches a compiler-coded complex password.

As regard the Cache List Generator Input Protocol, the data are supplied by the various domain name sources, e.g., HTTP Proxy Servers, DNS Servers etc., according to a predetermined Application Programming Interface (API). An UDP-based, thread safe API implemented, for example, in American National Standards Information (ANSI) C is provided that allows domain name popularity to be provided from platforms such as the HTTP Proxy server or the DNS server. This API, for instance, can utilize three arguments: domain name, hit count and a flag to indicate whether the record must be buffered prior to transmission to the Cache List Generator 601 or the record to be sent immediately. By default, the API buffers domain name records until the buffer limit of 1440 Bytes is attained. The API also internally ensures that if transmission of the input buffer would increase the packet size then it transmits the buffered set of records and buffers current set.

If bFlush is TRUE, then the API transmits whatever data is accumulated including the current list without buffering. This parameter ensures that the API does not need to implement a timeout internally, rather it is the responsibility of the calling application to use a timer so that records are sent regularly to the Cache List Generator 601. The API creates UDP packets and sends them over UDP to the Cache List Generator 601. This API, according to one embodiment of the present invention, also adds MD5 of a hard coded password and the input data at the end of the packet, thereby facilitating determination of authenticity of the information source.

Another API is provided to set the Cache List Generator IP addresses and port number for which the DNS record information has to be transmitted. This API is called by the sender in the start and reads the Cache List Generator redundant system IP addresses and port number from the registry.

These API's can be linked with the various domain name sources (e.g., HTTP Proxy Upstream Server and the DNS server) and will be called for sending domain name hit count information to Cache List Generator 601.

FIG. 8 shows an exemplary data structure for storing domain name hit count information, according to one embodiment of the present invention. The Input Process 603 maintains storage data structure 800 for keeping domain name popularity information. This storage structure 800 stores the domain name popularity information for M domains where M is a configurable parameter.

A domain name hash list (i.e., hash table) 801 contains indices, which represent pointers to a doubly linked list. By employing the data structure 800, the Cache List Generator 601 gains a number of advantages. One advantage is rapid update of the Hit count data for a domain name. Also, sorting of the domain names according to their hit counts is kept separated and can be executed in batch by the DNS Cache Entry Multicaster 607.

Insertion of a new node for a new domain name occurs every time a new input record is received from the source of the domain name information (e.g., HTTP Proxy server and DNS server). Also, update of the hit count for a domain name is performed every time an input record for a domain whose hit count is available is received from the source of domain name information. A search for a node in the structure 800 occurs every time an input record is received from the source of domain name information. Further, the popularity count for the domains is decreased upon taking of a snapshot.

Every node of the hash table 801 points to a corresponding double linked list node 803. Each Doubly Linked list node 803 contains domain name MD5, domain name string, hit count, next and previous pointer for maintaining doubly linked list. The hit count of absolute domain names is stored by setting the Most Significant Bit (MSB) of the hit count. For the domain names matching operator defined relative patterns, the second MSB of the hit count is set. The first two bits of the hit count field are used to distinguish between absolute, relative and other domain names.

The domain name hit count information is populated in the data-structure 800 as follows. The Cache List Generator 601 first scans the NOC 119 provided domain names. The NOC defined absolute domain names are populated in the hash table 801 with the MSB of the hit count set to 1, whereas relative domain names are stored in an array 805 as a string for comparisons later on while adding new entries.

This NOC 119 provided DNS list is modifiable, and the changes would be reflected after taking the snapshot. Before processing the list, its MD5 hash is calculated and compared with MD5 hash of the file when it was last read. This is performed to check whether the contents of the file were modified. If the file has been modified, then only the new list is processed.

The modified NOC-defined entries are processed as follows. Each domain name in the storage structure is scanned, and the first two MSB of the hit count are set to 0. Next, the absolute domain name from the file is read, and the hash is calculated. A check is made to determine whether the domain name is already present in storage structure set the MSB of the hit count to 1. If the domain name is not present in storage structure 800, a new node is added with the MSB of the hit count set to 1. The above process is performed for all absolute domain name entries in the file.

Next, all the NOC defined relative domain names are read from the file, and the array of NOC defined Relative Domain Names is populated. Each domain name is scanned, and a pattern match with the NOC provided list of relative domain names is performed. If a match exists, then the second MSB is set to 1.

After taking the snapshot of the first N popular domain names, the popularity of the domain names may have to be reduced by the configured amount to make the other entries competitive enough to remain in the race of most popular domain names. The policy adopted is to reduce the popularity of all the domain names by M %. When this limit of M is reached, then the Least Recently used (LRU) node is removed from the doubly linked list—which is already sorted on the basis of LRU. To avoid deleting a popular domain name, the first LRU whose hit count is greater than zero and less than the configured threshold value is chosen to be deleted. If no record with hit count below a LRU Hit Count Threshold, is found, the record with least hit count is replaced by the new one.

The DNS Cache Entry Multicaster 607 reads the file dumped by the Input Process 603 and populates the multicast array 403. There are two instances of this array populated, one for the absolute and relative domain names and another for the other domain names. Each array record contains domain name, hit count and the MD5 of that domain name. A sort algorithm (e.g., merge sort) is executed to arrange the DNS records in the decreasing order of popularity for both the arrays.

The list of the first N popular domain names is multicast as follows: Operator (i.e., NOC) defined Absolute domain name list entries from the first array (OA); Operator defined Relative domain name list entries from the first array: (OR); and (N−(OA+OR)) entries from the second array. For the first N most popular records, the IP addresses are resolved and populated to the multicast cache 403, which is sized to accommodate N most popular records in the multicast packet format. Once enough records have been resolved for a single Z packet, then that packet is multicast to the remotes.

According to one embodiment of the present invention, resolution of an IP address for a domain name is performed sequentially. In case of timeouts, the Cache List Generator 601 does not retry that domain name for resolution. These domain names are not resolved for any Y version change for current X version. The DNS record for resolved domain name is created taking domain name MD5 from this array and IP address and TTL retrieved as a result of DNS query.

The operation of the three processes 603, 605, 607 of the Cache List Generator 601 with respect to the data structure 800 is now described. According to one embodiment of the present invention, the Input Process 603 accepts domain name frequency information from a predetermined list of IP addresses in which the following condition is met:

MD5 (packet data+hard coded password)=MD5 contained in the packet.

The Input Process 603 discards the packets (e.g., UDPs) from all other sources other than those specified on the list. For example, if 10 upstream proxies exist in the system of FIG. 1, and an additional one is sought to be added, the address of this additional 1 Ith's address to the cache list generator's configuration file. As a matter of fact, this information goes from HTTP Proxy servers outside the firewall to the DNS cache list generator inside the firewall and having the password in the clear is deemed acceptable as these packets do not leave the facilities of the NOC 119 and are not visible on the public network. The HTTP Proxy server to Cache List Generator link can be implemented as a secured path.

The Input process 603 adds the domain name frequency information to the storage structure 800 such that DNS record are added/updated based upon its hit count. The Input process 603 can also increase the received hit count value to affect this frequency; e.g., adding a value of a 100 to the hit count.

Further, the Input Process 603 computes the MD5 of the new INI file and compares the result with the MD5 hash of the old INI file. If they are different, then the domain names in the storage structure 100 have to be re-assessed—identifying the names as absolute, relative, or other. The Input Process 603 starts iterating the doubly linked list containing the domain name records and for each domain name, depending upon the hit count, writes the record to the respective data file. The Input Process 603 also determines whether the record can be categorized under absolute or relative domain name. If there is a match with any of the absolute domain names, its MSB is set to 1. If, however, the record matches the relative domain name pattern, its second MSB is set to 1.

If there is no match with any of the absolute/relative list, then the following conditions are examined. If the record's original hit counts MSB is set to 1, then this MSB is set to 0. Also, if the original hit counts second MSB is 1, then this second MSB is set to 0. If the original hit count is non-zero and non-negative, the popularity can be reduced by a predetermined percentage.

Additionally, the Input process 603 periodically checks for the time at which to dump the data file into the storage structure 800 for handling by the DNS Cache Entry Multicaster 607. At such a time (which is a configurable parameter), the Input Process 603 re-reads the INI file, validates the operator defined relative domain names and opens the data files to be written. As previously discussed, the data file can be an ASCII file, whereby the internal field separator is a comma character (i.e., “,”). Upon producing the domain name information file, the Input Process 603 passes this generated file to the DNS Cache Entry Multicaster 607.

The DNS Cache Entry Multicaster 607 is a thread that monitors the state change, and sets the X Change event. The DNS Cache Entry Multicaster 607 waits for the event set by the Input process 603, which is an indication of the readiness of the data files containing the domain name information.

The DNS Cache Entry Multicaster 607 reads the two data files from the Input Process 603 into the data structure 800 and sorts both the arrays in the descending order of popularity. The DNS Cache Entry Multicaster 607 selects the first array containing the absolute domain names and the ones matching the relative domain names. If their count (M) is less than the configured value ‘N’, the DNS Cache Entry Multicaster 607 selects (N-M) records from the second array.

Also, the DNS Cache Entry Multicaster 607, in the On-line state, resolves the domain names and populates the multicast buffer; once a particular “Z” packet is filled, it is multicast before resolving the next domain name. During the address resolution, the DNS Cache Entry Multicaster 607 also keeps track of the minimum TTL (min TTL) across all the packets being multicast.

After finishing the resolution, the DNS Cache Entry Multicaster 607 repeats the multicasting until the time which is computed as follows: Minimum (min TTL, (time to complete 1 full multicast)*Number Of Re-transmissions). After stopping the retransmission, the DNS Cache Entry Multicaster 607 increments the Y version and starts re-resolving the IP addresses and TTL of the domain names. This process remains alive throughout the life span of the Cache List Generator 601.

If, for a given X and Y version, the DNS Cache Entry Multicaster 607 generates and transmits ‘m’ resolutions for a domain name then for all subsequent Y transmissions for the same X, the Cache List Generator 601 would transmit ‘m’ resolutions for that domain name. While performing the Y update, if the domain name resolution returned less than ‘m’ resolutions, the DNS Cache Entry Multicaster 607 will repeat the previous resolution in the transmission packet. This ensures that the same numbers of DNS records are packed in a multicast packet with same Z but different Y version. If this order is not maintained then it would lead to inconsistent multicast cache update at the remotes.

With respect to the Monitor Process 605, this thread monitors the X version change event from the Input Process 603. The Monitor Process 605 sets the following exemplary events: Shutdown event, and X version event.

The Monitor Process 605 can implement a concurrent server, wherein the Monitor Process 605 listens for connection requests. When the Monitor Process 605 receives a request, the process 605 creates a new thread to handle that request; this thread is active until the connection is up.

Whenever there is change in X version, the Monitor Process 605 receives an event raised by the DNS Cache Entry Multicaster 607, which requires the Monitor Process 605 to read the current value of X from the shared memory and communicate it to its peer.

The Monitor Process 605 also supports a TELNET interface to an operator (i.e., NOC). The operator can use this interface to command the Cache List Generator 601 to perform one of the following task: monitor various parameters; and command the Cache List Generator 601 to go Out of Service, to Shutdown, or to go back in service.

FIG. 9 is a sequence diagram of a DNS request in a transparent proxying architecture, in accordance with the embodiment of the present invention. For the purposes of explanation, it is assumed that the system 110 of FIG. 1 utilizes a Layer 4 switch in the router 111, and the proxy server 113 behaves as a DNS proxy; also, each machine is assumed to support UDP. In step 901, the web browser in the host 101 submits a DNS Request for the DNS server 117. The DNS Request, in this example, specifies a source address of “Local IP” (i.e., the address of the host 101) and a destination address of “DNS IP” (i.e. the address of DNS server 117); in which the source port is “A” and the destination port is “53”.

The Layer 4 Switch within the router 111 recognizes the DNS request by its destination port and routes, as in step 903, the request to the DNS proxy 113. The DNS request, at this point, is altered, whereby the source address is the “DNS IP” and the destination address is the “Proxy IP”; the source port is modified from port “A” to a Layer 4 pool port “P” and the destination port is “DNS proxy port X.” The DNS proxy stores in a record associated with port “P” the original source IP address and port of the request so that it can restore those values into the destination address and port of the DNS response in step 909 as discussed below.

If the requested DNS is in the DNS proxy cache of the DNS proxy, then a DNS response is sent back. However, if there is a cache miss, then the DNS request is sent to the DNS server 117, per step 905. In the case of a cache miss, the source address of the DNS request is changed from “DNS server IP” to “DNS proxy IP”, and the source port is changed from “P” to “X” where “X” is a value known to the Layer 4 switch and reserved for use by the DNS proxy 113. The destination port is changed to “53” (the DNS request server port) so that the DNS server will process the request. Because the request is from port “X” and destination port is “53,” the Layer 4 Switch would let the request pass. The Layer 4 switch would only intercept the packets with destination port “53” and source port all except proxy port “X.” In step 907, the DNS response received from the DNS Server 117 updates the DNS cache. The DNS response specifies the source address as “DNS Server IP”, the destination address as “Proxy IP”, the source port as “53”, and the destination port as “X”. Next, the DNS proxy sends the DNS response to the browser through the Layer 4 Switch, per steps 909 and 911. The DNS response from the DNS proxy server to the Layer 4 switch has the following parameters: a source address of “Proxy IP”, a destination address of “DNS IP”, a source port of “X”, and a destination port of “P.” The DNS response at the browser specifies a source address of “DNS Server IP”, a destination address of “Local IP”, a source port of “53”, and a destination port of “A.”

It is noted that a Layer 4 switch may be implemented in any network element that has access to the packets which are traversing the Wide Area Network (101). According to one embodiment of the present invention, the DNS proxy is utilized in one device, such as the proxy server 305; under such a scenario, all the Layer 4 switches are configured to the same DNS proxy IP and Port. As can be understood by one skilled in the art, the exact details of the modification of the addressing information and other fields of the request and response packets may be modified in other embodiments is such a way that the essence of the transparent switching is retained. This essence is that the request is redirected to the proxy and the response from the proxy is redirected to the originator of the request in a way that makes it appear that it came from the DNS server.

The Layer 4 switch needs to know whether the configured Proxy address is a local IP or non-local. If it is a local IP (i.e., the Layer 4 switch) and DNS proxy reside on the same machine (as is the case of the host 201 of FIG. 2), then the Layer 4 switch sends the packet up the protocol stack to the proxy. If the DNS configured IP is non-local, the packet is sent down towards the network. Thus, one of two different paths for the DNS request from the Layer 4 switch exists depending on the specific embodiment of the invention.

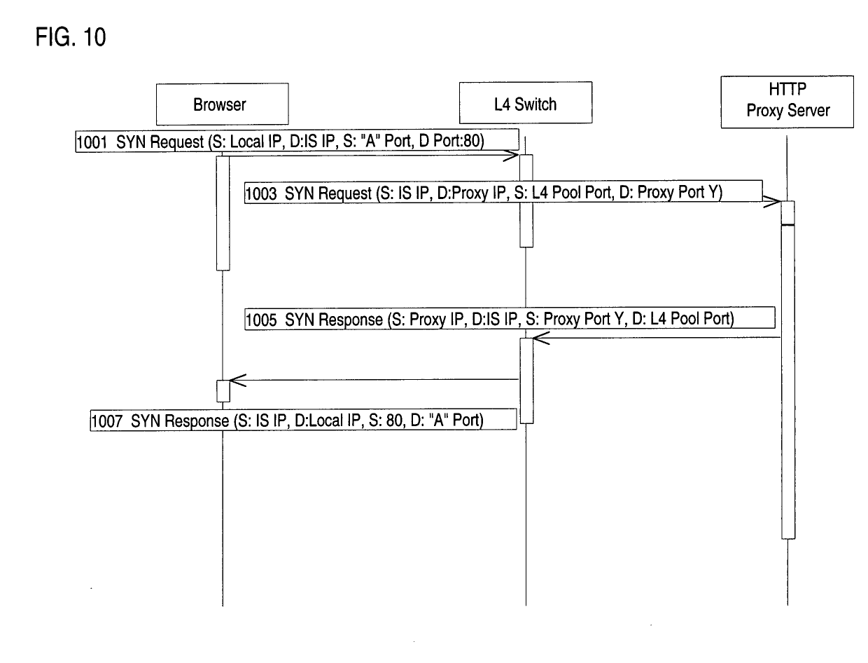

In addition to the DNS proxy services, the present invention, according to one embodiment of the present invention, also supports HTTP proxy services, as next discussed in FIG. 10.

FIG. 10 is a sequence diagram of a connection establishment request via a HyperText Transfer Protocol (HTTP) in a transparent proxying architecture, in accordance with an embodiment of the present invention. In this example, the HTTP proxy service is described with respect to the system of FIG. 1, wherein the proxy server 123 is assumed to be an HTTP proxy server. In step 1001, a browser within the host 101 issues a Connection Establishment request (e.g., a SYN request) to the web server 105. The SYN request from the browser specifies, for example, a source address of “Local IP” (i.e. host 101's address), a destination address of “IS IP” (corresponding to the web server 105), a source port of “A”, and a destination port of “80” (corresponding the HTTP protocol's server port). Next, in step 1003, the request for the web server 105 is routed to an HTTP Proxy 123; the SYN request is modified as follows: source address is changed from “Local IP” to “IS IP”, source port from “A” to “Pool Port P”, destination address from “IS IP” to “Proxy IP,” and destination port from “80” to “Proxy Port Y.” A Connection response (i.e., SYN response) from the HTTP proxy server 123 is routed to a Layer 4 switch, per step 1005. The SYN response specifies a source address of “Proxy IP”, a destination address of “IS IP”, a source port of “Proxy Port Y”, and a destination port of “L4 Pool Port.” The Layer 4 switch modifies the SYN response as follows: source address from “Proxy IP” to “IS IP,” source port from “Proxy Port Y” to “80,” a destination address from “IS IP” to “Local IP,” and destination port from “Pool Port P” to port “A”. When the Layer 4 switch modifies the addresses or ports, the TCP or UDP checksum along with the IP header checksum are appropriately updated to reflect the changed information.

In step 1007, this response from the Layer 4 switch is routed to the browser with the addressing modified so that the response appears to have originated from the web server 105. Other request and response packets for this TCP connection are similarly handled by the Layer 4 switch so that the connection is actually routed to the HTTP proxy server 123 but so that it appears to the browser that the connection is to web server 105. In order to do the restoral of the addressing performed in step 1007 above, the Layer 4 Switch maintains a TCP connection control block for each of the switched connections containing the original source IP address and port number for the connection. This control block is indexed by Pool Port P.

The processes of FIGS. 9 and 10 accordingly provide transparent forwarding of DNS requests and HTTP requests, respectively, without the need to configure the web browser on the client host.

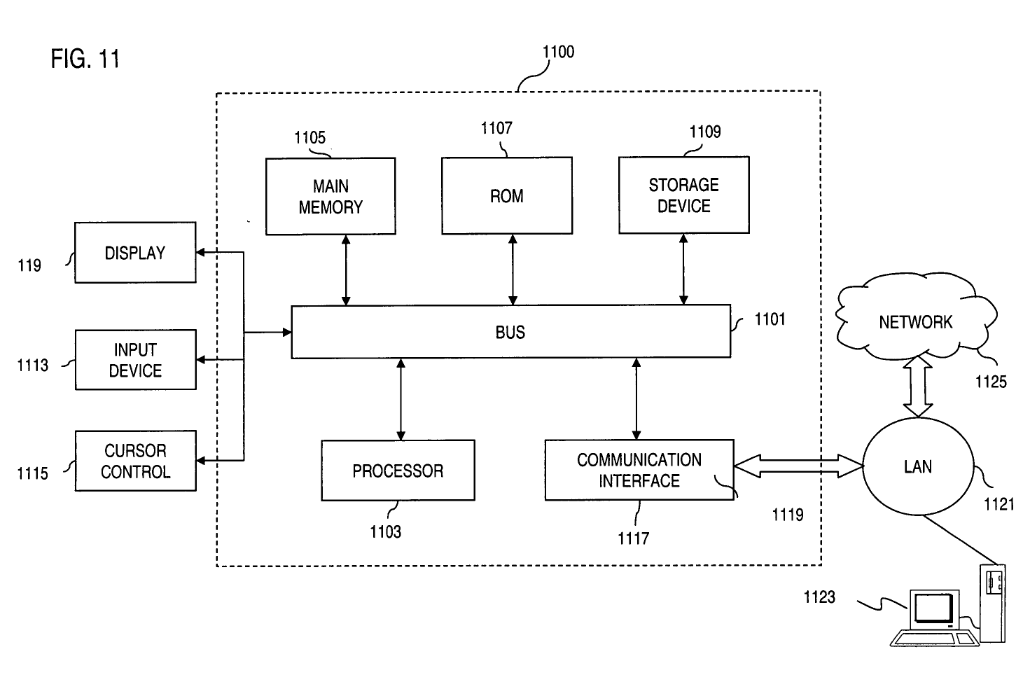

FIG. 11 illustrates a computer system 1100 upon which an embodiment according to the present invention can be implemented. The computer system 1100 includes a bus 1101 or other communication mechanism for communicating information and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to one embodiment of the invention, the cache list generator 601 is implemented by the computer system 1100 in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the present invention. Thus, embodiments of the present invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the present invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Accordingly, an approach is provided for multicasting of a list of network addresses that are pre-loaded into caches of the terminals (e.g., satellite terminals). Data, such as domain names, that indicates access of various network devices within a network (e.g., the Internet) is collected, for example, from a domain name source (e.g., proxy-cache server, DNS server, etc.). The list is generated, according to one embodiment of the present invention, based on popularity of the domain names. For example, hit count information can be used to determine popularity. A predetermined number of the domain names are selected for multicast to the terminals over, for example, a fixed, low bit rate. Upon receipt of the multicast of the list, the domain names are loaded into the terminal's cache in advance of any request by a host to access a device associated with the pre-loaded domain names.

While the present invention has been described in connection with a number of embodiments and implementations, the present invention is not so limited but covers various obvious modifications and equivalent arrangements, which fall within the purview of the appended claims.

What is claimed is:

1. A method for supporting address caching, the method comprising:
collecting data indicating access of network devices within a network;
generating a list specifying addresses corresponding to the network devices based on the collected data; and
preparing a message containing the list, wherein the message is multicast to a plurality of terminals in the network for pre-loading of respective caches of the terminals with the list of the addresses.

2. A method according to claim 1, further comprising:
multicasting the message at a low bit rate to the plurality of terminals.

3. A method according to claim 1, wherein the plurality of terminals in the preparing step are satellite terminals.

4. A method according to claim 1, wherein the addresses in the generating step include Internet Protocol (IP) addresses and are translated from respective domain names associated with the network devices.

5. A method according to claim 1, further comprising:
maintaining a count for each of the respective addresses based on the collected data.

6. A method according to claim 1, further comprising:
establishing a communication session with a peer process to convey state information for providing redundant operation.

7. A method according to claim 1, wherein the message in the preparing step includes,
a first field for indicating a change of one of the addresses in the list;
a second field for indicating age of the list; and
a third field for specifying a version of the list.

8. A computer-readable medium bearing instructions for supporting address caching, the instructions being arranged, upon execution, to cause one or more processors to perform the step of a method according to claim 1.

9. A system for supporting address caching, the system comprising:
a primary component configured to prepare a message containing network addresses of network devices that are accessed, wherein the message is multicast to a plurality of terminals for pre-loading of respective caches of the terminals; and
a secondary component configured to redundantly operate with the primary component by communicating with the primary component to receive state information of the primary component.

10. A system according to claim 9, wherein the message is multicast at a low bit rate to the plurality of terminals.

11. A system according to claim 9, wherein the plurality of terminals are satellite terminals.

12. A system according to claim 9, wherein the primary component collects data specifying domain names from a source that tracks the access of the network devices associated with the domain names.

13. A system according to claim 12, wherein the network addresses include Internet Protocol (IP) addresses and are translated from respective domain names associated with the network devices.

14. A system according to claim 12, wherein a predetermined number of the domain names are resolved to the network addresses according corresponding hit count information, the system further comprising:
a memory for buffering the pre-determined number of the network addresses.

15. A system according to claim 9, wherein the network addresses in the message are ordered according to decreasing hit count.

16. A method for resolving network addresses, the method comprising:
receiving a request to resolve a domain name to a network address;
determining whether the domain name corresponds to an entry of a first cache containing a plurality of network addresses that have been multicast from a predetermined terminal, wherein the plurality of network addresses is loaded into the first cache in advance of the receiving step;
in response to a miss in the first cache, determining whether the domain name corresponds to an entry of a second cache that is maintained locally; and
if the domain name yields a hit in either of the caches, responding to the request with the network address corresponding to the requested domain name stored in the respective cache.

17. A method according to claim 16, wherein the network addresses in the determining step are loaded at a low bit rate.

18. A method according to claim 17, wherein the network addresses in the determining step are multicast via a satellite.

19. A method according to claim 16, wherein the network addresses in the generating step include Internet Protocol (IP) addresses and are translated from respective domain names.

20. A method according to claim 16, wherein the request in the receiving step is transparently intercepted from a host, the method further comprising:
outputting a response specifying the requested domain name to the host.

21. A computer-readable medium bearing instructions for proxying address resolution, the instructions being arranged, upon execution, to cause one or more processors to perform the step of a method according to claim 16.

22. A network device for resolving network addresses from domain names, the device comprising:
a memory configured to cache a plurality of network addresses that have been multicast from a predetermined terminal;
a communications interface coupled to the memory and configured to receive a request to resolve a domain name to a network address; and
a processor configured to determine whether the domain name corresponds to an entry of the memory, wherein the processor selectively responds to the request with the network address corresponding to the requested domain name stored in the memory.

23. A device according to claim 22, wherein the network addresses are loaded at a low bit rate.

24. A device according to claim 23, wherein the network addresses are multicast via a satellite.

25. A device according to claim 22, wherein the network addresses include Internet Protocol (IP) addresses and are translated from respective domain names.

26. A device according to claim 22, wherein the request is transparently intercepted from a host, the host receiving a response specifying the requested domain name.

27. A computer-readable medium storing a data structure for supporting address resolution, the medium comprising:
a first section configured to pre-load a plurality of entries, each of the entries includes a domain name and an associated network address, wherein the entries have been multicast for the pre-loading; and
a second section configured to store a plurality of entries of domain names and corresponding network addresses that are retrieved independently from the multicast entries.

28. A computer-readable medium according to claim 27, wherein the sections share a common hash bucket.

29. A computer-readable medium according to claim 28, wherein each of the entries of the first section and second section includes a field specifying a next bucket.

30. A computer-readable medium according to claim 29, wherein each of the entries of the second section further includes a field specifying a next entry of the second section and a field specifying a previous entry of the second section.
